(19) United States
(12) Patent Application Publication
(10) Pub. No.: US 2015/0242000 A1
(43) Pub. Date: Aug. 27, 2015

(54) INPUT TOOLS FOR TOUCHSCREEN DEVICES

(71) Applicant: ADOBE SYSTEMS INCORPORATED, SAN JOSE, CA (US)

(72) Inventors: Geoffrey Dowd, San Francisco, CA (US); Gregory Cy Muscolino, Novato, CA (US); Timothy Ryan Van Ruitenbeek, Berkeley, CA (US)

(21) Appl. No.: 14/189,980

(22) Filed: Feb. 25, 2014

(51) Int. Cl. G06F 3/0354

(52) U.S. Cl. CPC G06F 3/03545

(57) ABSTRACT

An accessory device for providing input a touchscreen interface comprises a touchscreen ruler that provides uniquely identifiable and orientation-sensitive touch input to a touchscreen. The ruler can comprise a plurality of charge-conductive touchpoint elements mounted on a non-conductive frame such that the touchpoint elements are closely spaced from a support surface that engages the touchscreen in use. The touchpoint elements are conductively coupled to a touch receptor exposed to user touch during operation, causing indirect exposure of the touchpoint elements to the user's body capacitance. One of the touchpoint elements may be coupled to a user-operable switch mechanism to allow selective activation of the coupled touchpoint element.

### TECHNICAL FIELD

This disclosure generally relates to user input of information to an electronic device via a touchscreen interface. More particularly, the disclosure relates to devices and methods for input of graphical information on a touchscreen device.

### BACKGROUND

Touchscreen interfaces for electronic devices are becoming increasingly prevalent, for example, on electronic tablets, laptops, and touchscreen monitors. Use of touchscreen interfaces is particularly convenient in applications for producing or generating graphical content, such as drawing, graphic design, and photo processing applications. This is because the provision of input directly on a touchscreen on which the graphic content is displayed is more intuitive than input on a separate surface by, for example, a tracking device such as a mouse or a digital pen and tablet. Current modes of touchscreen input for such uses comprise single-point pen/stylus input, single-point manual touch input, and on multi-touch gesture recognition.

### BRIEF DESCRIPTION OF THE DRAWINGS

Example embodiments of the disclosure are illustrated by way of example, and not by way of limitation, in the figures of the accompanying drawings.

FIG. 1 is a schematic three-dimensional exploded view of a touchscreen input tool in the form of a touchscreen ruler, according to an example embodiment.

FIG. 2 is a schematic three-dimensional view from above of a touchscreen ruler, according to an example embodiment.

FIG. 3 is a schematic three-dimensional view from below of a touchscreen ruler, according to an example embodiment.

FIG. 4 is a schematic side view of a kit comprising a touchscreen ruler, according to an example embodiment, and an electronic touchscreen device in the form of a tablet device.

FIG. 5 is a schematic three-dimensional view from above of a graphical content creation system according to an example embodiment, with the system comprising a touchscreen ruler and an electronic device having a touchscreen interface.

FIG. 6 is a schematic three-dimensional view from above of a touchscreen ruler, according to a further example embodiment.

FIG. 7 is a schematic three-dimensional view from below of the touchscreen ruler, according to the further example embodiment.

FIG. 8 is a schematic longitudinal section of the touchscreen ruler, according to the further example embodiment of FIG. 6.

### DETAILED DESCRIPTION

In the following description, for purposes of explanation, numerous specific details are set forth to provide a thorough understanding of example embodiments. It will be evident to one skilled in the art, however, that the present subject matter may be practiced without these specific details.

### Overview

One aspect of the disclosure provides a touchscreen ruler that provides uniquely identifiable and orientation-sensitive indirect touch input to a touchscreen. Recognition of an on-screen position and an orientation of the touchscreen ruler by software executed on an electronic device coupled to the touchscreen thereby allows dynamic on-screen rendering of application-specific content (e.g., graphic content such as lines, figures, or curves) corresponding in position and orientation to the touchscreen ruler, without direct touch of the touchscreen by the user.

Such indirect touch input may be provided by a plurality of charge-conductive touchpoint elements mounted on a non-conductive frame, with the touchpoint elements being conductively connected to a touch receptor exposed to user touch during operation. When the user handles the touchscreen ruler, touching the touch receptor, the touchpoint elements are indirectly exposed to human body capacitance and cause distortion of an electrostatic field of the touchscreen. Such distortion is registered as a multi-point touch input by a capacitive touchscreen.

As will be described in further detail below, some embodiments may include at least one selectively activatable touchpoint element to convey additional user-selected input to the electronic device via its touchscreen interface. Instead, or in addition, the touchscreen ruler may provide a movable touchpoint that is slidable along a straight longitudinal edge of the touchscreen ruler responsive to corresponding user input to the touchscreen ruler. In some embodiments, the touchscreen ruler may be translucent (for example, being substantially transparent).

As described herein, in some example embodiments, systems and methods are described that are configured to generate, process, create, and/or edit image content and/or create modified or simulated images via an image or photo editing application, such as the Adobe® Photoshop® family of applications. The technology may be implemented by one or more applications resident on a computing device (e.g., mobile computing device) and/or in a networked environment (e.g., a cloud-based network environment) where processing may or may not be distributed.

### Example Embodiment

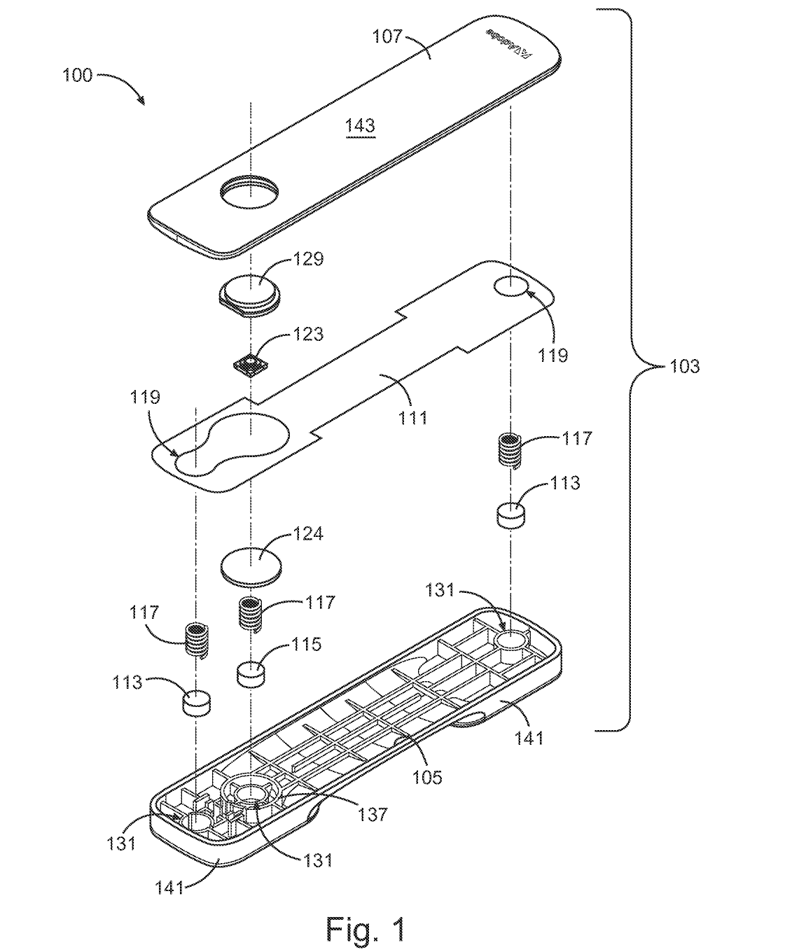

In FIG. 1, reference numeral 100 generally indicates a touchscreen input device in the example form of a touchscreen ruler. As will be described in greater specificity below, the ruler 100 provides a pair of primary touchpoint elements 113 that are conductively connected to a touch receptor that provides a manual touch interface (in this example comprising metallic top plate 107), so that the primary touchpoint elements 113 automatically approach the capacitance of a user touching the touch receptor. The effective extension of a user's body capacitance to the primary touchpoint elements 113 causes registration of simultaneous, spaced touchpoint inputs on the touchscreen corresponding to the positions of the primary touchpoint elements.

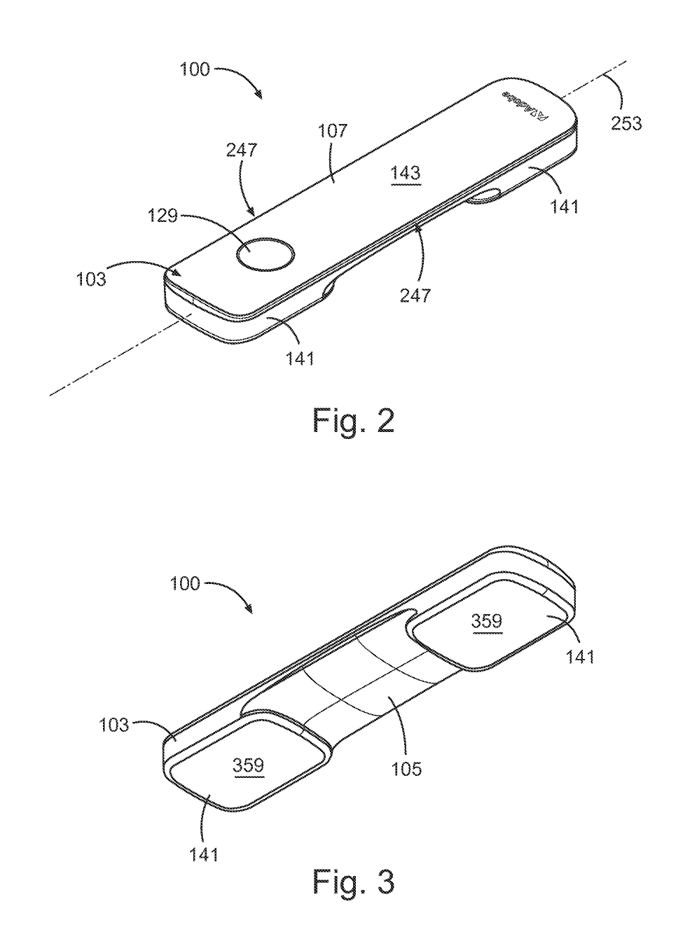

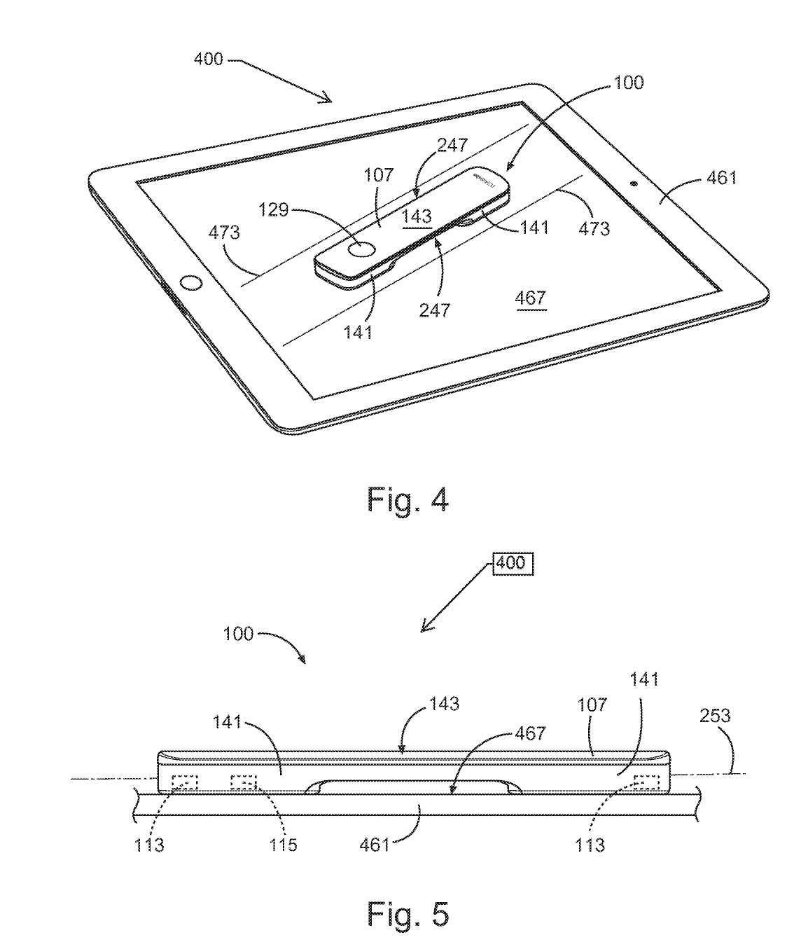

The ruler 100 has an elongate composite body 103 that is generally ruler-shaped in that it has a length dimension that is significantly greater in magnitude than orthogonally transverse width and height dimensions. The length dimension of the body 103 defines a lengthwise axis 253 (see FIG. 2) of the ruler 100. The body 103 is shaped and configured such that, when the ruler 100 is in operation placed against a touchscreen (see, for example, FIGS. 4 and 5), the lengthwise axis 253 of the ruler 100 is substantially parallel to the touchscreen.

The composite body 103 forms a housing provided by the metal top plate 107 (in this example being of aluminum) and a dielectric frame 105 of a non-conductive material. The frame 105 may be of a polymeric plastics material, which in this example embodiment is a molded Acrylonitrile Butadiene Styrene (ABS)-Polycarbonate (PC) mixture. The frame 105 is identical in peripheral outline to the top plate 107, when viewed in a direction perpendicular to the width and the length of the ruler 100. Bearing in mind that the touchscreen ruler 100 is shaped for user manipulation in a manner similar to traditional rulers, the top plate 107 and the complementary frame 105 have elongate rectangular peripheries. The ruler 100 (and, in particular, the top plate 107) therefore provides a pair of parallel, transversely spaced straight edges 247 (see FIG. 2) that extend lengthwise along the ruler 100, parallel to the lengthwise axis 253. An operatively upper surface of the top plate 107 defines a touch surface 143 exposed in use to manual touch by the user. In this example embodiment, substantially the entire exposed upper surface of the ruler 100 forms part of the touch surface 143, so that a user will invariably touch the touch surface 143 when manipulating the ruler 100, in use.

Returning now to FIG. 1, it will be seen that the composite body 103 provides a housing for a pair of primary touchpoint elements 113, as well as for an additional selective touchpoint element 115. Each touchpoint element 113, 115 comprises a mass of material whose properties are such as to cause distortion in an electrostatic field of an adjacent touchscreen 467 (see FIG. 4), thereby registering a touchpoint input on the touchscreen 467. As can be seen in FIG. 1, each touchpoint element 113, 115 in this example embodiment comprises a circular cylindrical pellet-shaped mass having a polar axis oriented perpendicularly to the length and width of the composite body 103, so that, in operation, the polar axis of each touchpoint element 113, 115 is substantially perpendicular to the touchscreen 467 with which the ruler 100 cooperates. The touchpoint elements 113, 115 may be of a metallic material, and may in some embodiments be of a metal oxide. In this example embodiment, each touchpoint element 113, 115 is of a paramagnetic material (for example, a ferrite element). The touchpoint elements 113, 115 of the described example embodiment are therefore substantially non-conductive, but serve to cause touchscreen electric field distortion due to the paramagnetic nature of touchpoint elements 113, 115 when exposed to a user's body capacitance by conductive coupling to the top plate 107. In other example embodiments, the touchpoint elements 113, 115 may be of a conductive material (for example, copper). In yet further embodiments, the touchpoint elements 113, 115 may be of a conductive ferrous alloy.

A permanent conductive coupling is, in this example embodiment, provided between each of the primary touchpoint elements 113 and the top plate 107. In this example, the permanent conductive coupling is provided by resilient bias members in the example form of respective helical compression springs 117 acting directly between the respective touchpoint element 113, 115 and the top plate 107. An operatively lower end of each one of the coil springs 117 therefore abuts against a circular top surface of the corresponding primary touchpoint element 113, while an operatively upper end of the spring 117 abuts against an inner surface of the top plate 107. The springs 117 are of an electrically conductive material, therefore conductively coupling the primary touchpoint elements 113 and the top plate 107. Resilient resistance of the compression springs 117 to compression serves the dual purposes of (a) urging the respective touchpoint elements 113, 115 operatively downwards into the frame 105, towards a support surface provided by respective pad surfaces 359, and (b) promoting positive conductive contact between the respective primary touchpoint elements 113 and the top plate 107.

In contrast, a selectively switchable conductive coupling is provided between the selective touchpoint element 115 and the top plate 107. In this embodiment, the conductive coupling between the selective touchpoint element 115 and top plate 107 is switchable from an open condition to a closed condition by pressing a press button 129 accessible via the top plate 107. The press button 129 can itself be charge-conductive, in this example being of aluminum. As shown in the exploded view of FIG. 1, the switchable conductive coupling between the top plate 107 and the selective touchpoint element 115 (which is identical in shape, dimension, and material composition to the primary touchpoint elements 113) comprises (a) a helical compression spring 117 identical to those coupled to the primary touchpoint elements 113; (b) a circular disc-shaped contact plate 124 against which an operatively upper end of the contact spring 117 abuts; (c) the button 129 located in a complementary aperture defined by the top plate 107; and (d) a tactile switch 123 sandwiched between the button 129 and the contact plate 124. In a default mode, in which the button 129 is not pressed by a user, the selective touchpoint element 115 is conductively isolated from the top plate 107 by operation of the switch 123 (which is open unless closed by a user actuation of the button 129). When the user presses the button 129, the switch 123 is closed, causing the selective touchpoint element 115 to be conductively coupled to the top plate by metal-to-metal contact between the spring 117 and the contact plate 124, between the contact plate 124 and the switch 123, between the switch 123 and the button 129, and between the button 129 and the top plate 107.

The non-conductive polymeric plastics frame 105 defines respective recesses 131 for each of the touchpoint elements 113, 115. Each recess 131 is a circular cylindrical channel extending perpendicularly to the width and the length of the body 103, and is complementary to the respective touchpoint elements 113, 115. Due in part to operation of the respective springs 117, each touchpoint element 113, 115 seats in a base of the corresponding recess 131. As shown schematically in FIG. 5, the touchpoint elements 113, 115 are in these positions closely spaced from the support surface configured for lying flat against the touchscreen 467, supporting the ruler 100 on the touchscreen 467. Returning now to FIG. 1, can be seen that the recess 131 for the selective touchpoint element 115 is provided by a co-axial guide tube 137, complementary to the contact plate 124, to guide axial movement of the contact plate 124 responsive to a user's pressing and releasing the button 129.

In this example embodiment, the support surface comprises a pair of flat pad surfaces 359 (FIG. 3) provided by respective foot formations or feet 141 defined by the frame 105. The pad surfaces 359 are substantially parallel to the lengthwise axis 253 of the body 103, so that the lengthwise axis 253 of the ruler 100 is substantially parallel to the touchscreen 467 when the pad surfaces 359 are laid flat against the touchscreen 467, as shown in FIG. 5. Each of the touchpoint elements 113, 115 is housed in one of the feet 141. In this example embodiment, a thickness of a layer of plastics material defining the respective pad surfaces 359 is less than 1 mm, so that, in operation, a transverse spacing between the touchscreen 467 and the respective touchpoint elements 113, 115 is less than 1 mm.

Referring again to FIG. 1, it will be seen that the body 103 has a fixed spatial arrangement between the respective touchpoint elements 113, 115, so that the ruler 100 has a unique, fixed touchpoint signature recognizable through the operation of cooperating software executing on an electronic device coupled to a touchscreen interface engaged, in use, by the ruler 100. In this embodiment, the primary touchpoint elements 113 are spaced along the length of the body 103, being located adjacent opposite ends of the ruler 100. Although the primary touchpoint elements 113 are, in this example, located on the ruler 100's longitudinal centerline (which is defined by the lengthwise axis 253), the touchpoint elements 113, 115 may, in other embodiments, be laterally offset from the longitudinal centerline of the body 103.

The composite body 103 may further comprise a fastening element in the example form of a fastener sheet 111 for ease of connection between the frame 105 and the top plate 107. The fastener sheet 111 may be a VHB (Very High Bond) sheet that is adhesively connected both to the frame 105 and the top plate 107. The fastener sheet 111 may be provided with respective openings 119 to allow passage therethrough of the conductive coupling between the top plate 107 and the respective touchpoint elements 113, 115.

In operation, the ruler 100 can be used to provide consistent, automated multitouch input to a touchscreen interface. FIGS. 4 and 5 show an example system 400 comprising the example ruler 100 and a touchscreen device in the form of an electronic tablet device 461, which in this example is an iPad™ produced by Apple, Inc. In conventional fashion, the tablet device 461 has a flat, rectangular capacitive touchscreen 467. The ruler 100 is dimensioned for use with the tablet device 461, in that the length of the ruler 100 is somewhat smaller than a width of the tablet device 461. In this example embodiment, the width of the tablet device 461 is about 19 cm, while the length of the ruler 100 is about 15 centimeters. Note that the a ratio between the length of the touchscreen ruler 100 and a smallest dimension of the touchscreen 467 (in this example its width) is about 0.8.

To use ruler 100 for information input, a user places the ruler 100 flat against the touchscreen 467 (see, e.g., FIGS. 4 and 5) in a manner similar to the conventional use of a traditional, non-digital ruler on a paper page. The pad surfaces 359 provided by bottom faces of the feet 141 are thus in face-to-face engagement with the touchscreen 467. In this orientation, the ruler 100 extends along the touchscreen 467, in that the lengthwise axis 253 is substantially parallel to touchscreen 467.

As can be seen in FIG. 5, the touchpoint elements 113, 115 are closely spaced from the touchscreen 467 when the ruler 100 is in its operative position and are separated from the touchscreen 467 by a spacing smaller than 1 mm. In some embodiments, the spacing is smaller than 0.5 mm. When the user touches the top plate 107, for example to hold or move the ruler 100 on the touchscreen 467, the primary touchpoint elements 113 are exposed to the body capacitance of the user via the top plate 107 and the respective conductive springs 117. A resultant change in capacitance of the touchpoint elements 113, 115 causes distortion in an electrostatic field generated by the touchscreen 467, causing registration of a multitouch input at the respective positions of the primary touchpoint elements 113. In some embodiments, registration of the multitouch input by the touchscreen 467 may be by provision of a grounding path provided by the user's body via the top plate 107.

Differently described, the ruler 100 provides a fixed formation multitouch extension of the user's body capacitance. Software executing on the tablet device 461 may be configured to recognize the ruler 100 based on the spacing between the primary touchpoint elements 113. Under direction of such software, the tablet device 461 is therefore configured to automatically detect multitouch input comprising two touchpoints spaced apart at the particular spacing between the primary touchpoint elements 113, and to automatically associate such detected multitouch input with the ruler 100. The spatial arrangement of the touchpoints provided by the primary touchpoint elements 113 therefore effectively serve as a fingerprint associated with the ruler 100. In some embodiments, each one of a plurality of peripheral touchscreen input tools may have a respective, unique touchpoint fingerprint, and the software executing on the tablet device 461 may be configured to automatically distinguish between the respective input tools and to automatically render corresponding material on the touch feet 141.

In some example embodiments, the tablet device 461 may run software for generating graphical content, for example executing a graphic design application such as Adobe Illustrator™ or a photo processing application such as Adobe Photoshop™. In this example embodiment, a graphic design application executing on the tablet device 461 is configured to automatically generate parallel trace lines 473 on a display provided by the touchscreen 467, in response to recognizing multitouch input via the ruler 100. As shown schematically in FIG. 4, the trace lines 473 are parallel to but naturally spaced from the straight edges 247 of the ruler 100. Note that the longitudinal spacing between the primary touchpoint elements 113 serves not only to uniquely identify the ruler 100, but also facilitates accurate detection of the linear orientation of the ruler 100 on the touchscreen 467. This promotes accurate rendering of the trace lines 473 parallel to the straight edges 247 of the ruler 100. The user can then draw a line coincident with one of the trace lines 473 by touching and sliding a finger or pen/stylus on the touchscreen 467 adjacent the selected trace line 473.

In this example embodiment, additional functionalities associated with the touchscreen ruler 100 in the software executing on the tablet device 461 can be accessed by operation of the button 129 on the ruler 100. When the user presses the button 129, the tactile switch 123 is closed, thereby creating a conductive coupling of the selective touchpoint element 115 with the user's body. Due to the user's body capacitance, to which the selective touchpoint element 115 is now exposed, the selective touchpoint element 115 is electrostatically charged and causes localized distortion of the electrostatic field of the touchscreen 467. In other words, pressing of the button 129 causes registration of a third touchpoint input on the touchscreen 467.

The graphic design software executing on the tablet device 461 is configured to recognize activation of the selective touchpoint element 115 (bearing in mind that the selective touchpoint element 115 is in a fixed, predetermined spatial relationship relative to the primary touchpoint elements 113). In response to receiving the selective touchpoint input resulting from pressing of the button 129, the graphic design software on the tablet device 461 may make available one or more functionalities that are associated in the software with button activation. In this example embodiment, the trace lines 473 may be replaced by predefined geometric figures or curves responsive to pressing of the button 129, so that additional user input on the screen causes tracing of the respective figure or curve in part or in whole.

In some embodiments, repeated pressing of the button 129 causes cycling through a predefined series of figures and/or curves. In some embodiments, the ruler 100 may have only the primary touchpoint elements 113, while other embodiments may have a plurality of selective touchpoint element 115 for activation by respective switching mechanisms (e.g., by respective press buttons). Note further that the touchscreen ruler 100 can, in other embodiments, be used for providing touchscreen input to software applications that are not specifically focused on the generation of graphical content. One such example may comprise use of the ruler 100 in a text-based application to select particular text sequences for formatting (e.g., for underlining). In some embodiments, the coupling mechanism of the press button 129 is configured such as not only to couple the selective touchpoint element 115 conductively to the top plate 107, but simultaneously to disconnect on of the primary touchpoint elements 113 from exposure to human body capacitance, e.g., by decoupling it from the top plate 107 and press button 129. In such an embodiment, only two touchpoint elements provide touchscreen input at any time, but the lengthwise spacing between the activated touchpoints varies depending on the activation status of the press button 129. Software executing on the tablet device 461 will is such case be programmed to recognize and respond to the respective activation modes indicated by the respective two-point input modes. Such simultaneous coupling/decoupling of a pair of touchpoint elements may be accomplished using a dual pole single-throw switch. A benefit of effectively switching the relative position of a second one of the touchpoint elements (as opposed to activating a third touchpoint element) is that a possibility of overwhelming or confusing touch sensing by the tablet device 461 is reduced, thereby promoting reliability of the ruler 100.

It is a benefit of the example touchscreen ruler 100 as described above that it provides for more intuitive and precise touchscreen input than conventional touchscreen input techniques relying exclusively on finger-touch and gestures and/or pen/stylus input. Most users are familiar and comfortable with using a ruler for non-digital drafting (particularly for graphical design or drawing purposes) and are thus expected to experience little difficulty in learning to use the touchscreen ruler 100 effectively.

A further benefit of the ruler 100 is that direct touching of the touchscreen 467 is reduced, because the human touch interface is effectively transitioned from the touchscreen 467 to the touch interface provided by the top plate 107. Reduced manual interaction with the touchscreen 467 tends to reduce display quality degradation due to fingerprints and smudging on the touchscreen 467.

Yet further, the provision of an auxiliary or additional input mechanism, for example in the form of the press button 129, amplifies the user's input capacity to the touchscreen 467 without reducing available screen space by displaying touch-selectable user interface elements on the touchscreen display. Greater functionality of the relevant software application can thus be made instantly available to the user via the touchscreen ruler 100.

Another benefit of the example touchscreen ruler 100 is that the ruler 100 can function without any source of electrical power and without a data communication link with the electronic device 461. Reliability of operation is thus promoted by achieving functionality without the need, for example, of chemical batteries. Moreover, the example ruler 100 is a wireless peripheral, promoting ease of use and freedom of movement of the ruler 100 on the touchscreen.

The provision of paramagnetic touchpoint elements, such as the example ferrite slugs, has been found to provide improved touchpoint input. It is believed that the response of a ferrite element (or of an element of similar material) more closely resembles that of a human finger, therefore more closely mimicking actual touch input.

In some embodiments, however, the ruler 100 may include a communication device mounted in the body 103 for establishing a wireless communication link with the tablet device 461. In one example, the ruler 100 may house a transceiver configured for communicating with the tablet device 461 via a communication link using a protocol such as Bluetooth™ or WiFi. In such cases, the ruler may have one or more function buttons/selectors instead of or in addition to the button 129. User selection of such additional or alternative function buttons/selectors may be communicated to the tablet device 461 via the wireless communication link (instead of via activation of one or more respective additional touchpoint elements such as additional touchpoint element 115 in the above-described example embodiment), triggering execution of respective selected functions by software executing on the electronic device 461.

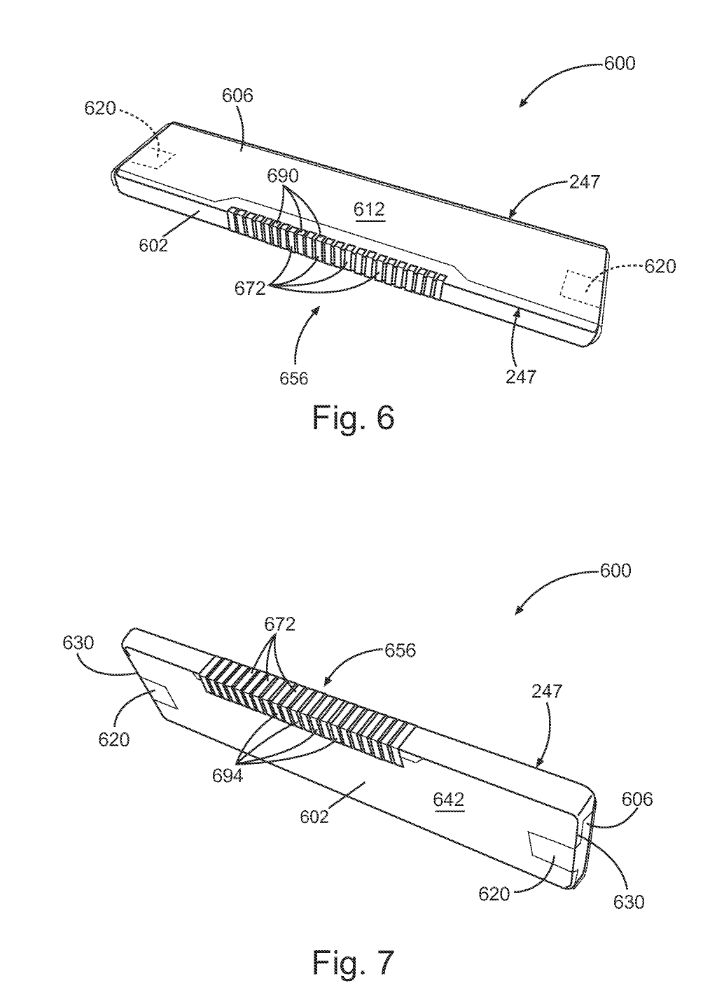

FIG. 6 shows another example embodiment of a touchscreen ruler 600. A distinction between the ruler 600 of FIG. 6 and the ruler 100 described with reference to FIGS. 1-5 is that the ruler 600 is translucent (in this example embodiment being substantially transparent).

The ruler 600 in this embodiment has an elongate tile-shaped body 602 of a substantially transparent plastics material (e.g., Perspex). The body 602 is thus substantially parallelepipedal, having a pair of elongate rectangular, parallel major faces connected by a peripheral interface extending transversely between the major faces. An operatively bottom one of the major faces provides a planar bottom surface 642 (see FIG. 7) for lying flat against a touchscreen 467 when in use. A length and width of the ruler 600, is defined by the length and width of the body 602's major faces, with a longitudinally extending side edge of an upper one of the major faces defining parallel straight edges of the body 602.

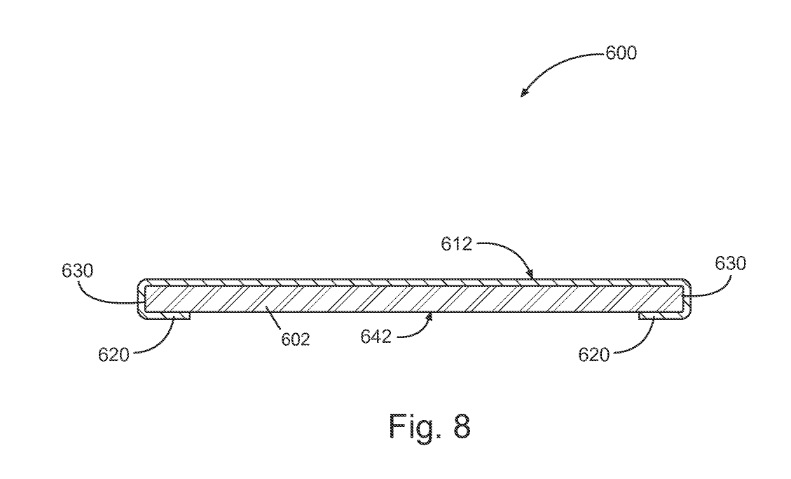

A clear conductive coating or sheet may be carried on the topmost major face of the body 602 to provide a touch interface analogous to that provided by the top plate 107 of the embodiment described with reference to FIG. 1. In this example embodiment, a conductive sheet 606 is adhesively attached to the upper major face of the body 602 to provide an outermost touch surface 612 for exposure to human touch. The conductive sheet 606 wraps around opposite end edges 630 (see FIGS. 7 and 8) of the body 602 to provide contact tabs 620 on the bottom surface 642 (see FIG. 8). Each contact tab 620 thus provides a touchpoint element that is conductively coupled to the touch surface 612, so that user contact with the touch surface 612 while the bottom surface 642 bears against the touchscreen 467 causes registration of simultaneous touchpoint inputs at the respective contact tabs 620. In this example embodiment, the conductive sheet 606 is a laminate element of one-piece construction providing both the touch surface 612 and the contact tabs 620.

The conductive sheet 606 is, in this example embodiment, provided by clear conductive antistatic tape carrying silver nano-wires. The clear tape thus provides an adhesive-backed film to which the conductive nano-wires are attached. Transparency of the conductive elements may, in other embodiments, be achieved differently (for example, by provision of an indium tin oxide coating that may be applied to a transparent sheet or may be applied directly to the transparent polymeric plastics material of the body 602). In further embodiments, conductors (such as the silver nano-wires used here) may be embedded in the body 602 (for example. molded into the body 602).

The ruler 600 further includes a slidable touchpoint mechanism 656 configured for providing a movable touchpoint input on one side edge of the ruler 600. As can be seen in FIG. 6, the conductive sheet 606 is clear of the slidable touchpoint mechanism 656, so that the slidable touchpoint mechanism 656 and the contact tabs 620 are conductively isolated from one another unless the user touches the slidable touchpoint mechanism 656. The slidable touchpoint mechanism 656 in this embodiment comprises a longitudinally extending series of closely spaced slider elements in the example form of slider contacts 672, each of which is provided by a conductive strip that wraps around the edge face of the body 602, having end portions respectively on the top face and on the bottom surface 642 of the body 602. The topmost end portion of each slider contact 672 provides a touch sensor 690 for contact with a user's finger. The bottommost end portion of each slider contact 672 provides a screen contact 694 on the bottom surface 642 to cause distortion of the touchscreen 467 electrostatic field due to conductive coupling of the screen contact to the user's body capacitance. In this example embodiment, the slider contacts 672 are made of a metal foil. In other embodiments, the slider contacts 672 can be constructed differently (for example, being of a transparent material similar to that of the conductive sheet 606).

The size and spacing of the touch sensors 690 are such that multiple touch sensors 690 are touched simultaneously when engaged by a human finger. Because each of the touched sensors 690 is conductively connected to the corresponding screen contact 694, a sufficiently large aggregate touchpoint is created for registration as a single touch input at the corresponding point on the touchscreen 467. If a user slides her finger along the series of touch sensors 690, a moving touch point is created on the touchscreen 467, simulating a slider motion on the ruler 600.

Referring briefly again to FIG. 4, it will be appreciated that use of the slidable touchpoint mechanism 656 of the ruler 600 (instead of a conventional touchpoint input as described with reference to the embodiment of FIG. 4) can allow a user to draw a line along all or part of a selected one of the trace lines 473 without directly touching the touchscreen 467.

It is a benefit of the transparent ruler 600 of FIGS. 6-8 that presence of the ruler on the touchscreen 467 does not fully occlude the user's view of parts of the touchscreen 467 coincident with the ruler 600. A further benefit is that provision of the slidable touchpoint mechanism 656 tends to reduce manual interaction with the touchscreen 467, thereby promoting screen clarity and reducing abrasive wear to which the touchscreen 467 may potentially be exposed.

One aspect of the disclosure realized by the above describe example embodiments includes a touchscreen input device comprising, at least: (a) an elongate body defining a support surface configured for supporting the body on an electronic touchscreen such that the body extends lengthwise along the touchscreen; (b) a conductive touch receptor incorporated in the body and defining a touch surface configured for exposure to user touch engagement when the body is supported by the support surface; (c) a plurality of touchpoint elements mounted on the body and configured for providing respective touchscreen touchpoints in response to exposure thereof to human body capacitance; and (d) a conductive coupling arrangement that provides a conductive coupling between each of the plurality of touchpoint elements and the conductive touch receptor, to cause exposure of each of the plurality of touchpoint elements to human body capacitance via the conductive coupling arrangement in response to reception of user touch by the touch receptor.

Another aspect of the disclosure comprises a method of providing input to a touchscreen device, the method comprising placing touchscreen input device as described above on a touchscreen interface, and causing exposure of a plurality of touchpoint elements housed on the input device to human body capacitance, to provide indirect multitouch input to the touchscreen interface.

Yet a further aspect of the disclosure comprises a system comprising an electronic device having a touchscreen, and a touchscreen input device as described above. The touchscreen input device may have a length dimension smaller than a width dimension of the touchscreen. In some embodiments, a ratio between the length of the input device and the width of the touchscreen may be 0.7-0.9.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals.” or the like. These words, however, are merely convenient labels and are to be associated with appropriate physical quantities.

Unless specifically stated otherwise, discussions herein using words such as “processing,” “computing,” “calculating.” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A touchscreen input device comprising:
an elongate body defining a support surface configured for supporting the body on an electronic touchscreen such that the body extends lengthwise along the touchscreen;
a conductive touch receptor connected to the body and defining a touch surface configured for exposure to touch by a user when the body is supported by the support surface;
a plurality of touchpoint elements mounted on the body and configured for providing respective touchscreen touchpoints on the electronic touchscreen; and
a conductive coupling arrangement that provides a conductive coupling between each of the plurality of touchpoint elements and the conductive touch receptor, to cause exposure of each of the plurality of touchpoint elements to human body capacitance via the conductive coupling arrangement in response to the user touching the touch receptor.

2. The device of claim 1, wherein each of the plurality of touchpoint elements is located between the support surface and the touch receptor, with respect to a height direction transverse to a length and a width of the elongate body.

3. The device of claim 2, wherein the support surface is provided by a component of the body that is of a non-conductive synthetic material, each one of the plurality of touchpoint elements being spaced from the support surface by a layer of the non-conductive synthetic material.

4. The device of claim 3, wherein the spacing between each one of the plurality of touchpoint elements and the support surface is 1 mm or less.

5. The device of claim 1, wherein each touchpoint element is of a material selected from the group consisting of: a conductive material, a metallic material, a paramagnetic material, and a ferrite material.

6. The device of claim 1, wherein the conductive touch receptor comprises an elongate conductive plate extending lengthwise along the body.

7. The device of claim 6, wherein the conductive plate from at least part of an operatively upper surface of the body.

8. The device of claim 6, wherein the conductive coupling arrangement comprises one or more resilient bias members urging respective touchpoint elements towards the support surface, each resilient bias member being of a conductive material and being conductively connected to the touch receptor and to at least one of the plurality of touchpoint elements.

9. The device of claim 1, wherein the plurality of touchpoint elements comprises a pair of primary touchpoint elements located adjacent opposite lengthwise ends of the body.

10. The device of claim 9, wherein:
the body defines a pair of foot formations at the opposite lengthwise ends, each foot formation being of a non-conductive material and providing a respective portion of the support surface; and
at least a respective one of the plurality of touchpoint elements is housed in each foot formation.

11. The device of claim 1, wherein the body defines a pair of straight, parallel edges extending lengthwise along the device.

12. The device of claim 1, wherein the plurality of touchpoint elements includes a selective touchpoint element, the device further comprising a user-operable switch mechanism connected between the touch receptor and the selective touchpoint element, the switch mechanism being disposable between:
an open condition in which the selective touchpoint element is conductively isolated from the touch receptor; and
a closed condition in which the touchpoint element is conductively connected to the touch receptor.

13. The device of claim 12, wherein the user operable switch mechanism comprises a press-button on an operatively upper surface of the body.

14. The device of claim 1, wherein the body is of a non-conductive translucent material.

15. The device of claim 14, wherein the touch receptor comprises a translucent conductive laminate member attached to an operatively upper major face of the body.

16. The device of claim 15, wherein a pair of the plurality of touchpoint elements respectively comprises a translucent conductive laminate patch attached to an operatively bottom surface of the body and forming part of the support surface.

17. The device of claim 16, wherein the touch receptor and the laminate patches are provided by a one-piece laminar component extending lengthwise along the body and wrapping around opposite ends of the body.

18. The device of claim 1, further comprising a moving touchpoint mechanism configured to transfer to the touchscreen a moving touchpoint input received from a user.

19. The device of claim 18, wherein the moving touchpoint mechanism comprises a longitudinal spaced series of slider elements fixedly mounted on a rectilinear side edge of the body, each slider element comprising a touch sensor located on an operatively upper surface of the body, and each touch sensor being conductively coupled to a corresponding screen contact at or adjacent the support surface.

20. The device of claim 19, wherein a size of the touch sensors and a spacing between neighboring touch sensors are selected such that touch input comprising finger movement along the series of slider elements causes simultaneous touch engagement with a plurality of the touch sensors.
